(19) United States
(12) Patent Application Publication
(10) Pub. No.: US 2011/0156614 A1
(43) Pub. Date: Jun. 30, 2011

(54) CIRCUIT AND METHOD FOR DIMMING A LUMINOUS ELEMENT

(75) Inventor: Juergen Klier, Traunreut (DE)

(73) Assignee: OSRAM GESELLSCHAFT MIT BESCHRAENKTER HAFTUNG, Muenchen (DE)

(21) Appl. No.: 13/060,706

(22) PCT Filed: Sep. 17, 2008
(86) PCT No.: PCT/EP2008/062352

§ 371 Date: Feb. 25, 2011

(51) Int. Cl. H05B 37/02

(52) U.S. Cl. 315/294

(57) ABSTRACT

In various embodiments, a circuit for dimming at least one luminous element is provided. The circuit may include at least two switching inputs and an N-connection, wherein on the basis of a switching combination of the switching inputs the at least one luminous element is dimmable, wherein as a function of a voltage shape across the N-connection the at least one luminous element is dimmable.

The invention relates to a circuit and a method for dimming a luminous element.

As solutions for dimming luminous elements various approaches exist.

For domestic installations there are approaches whereby an operating device for a luminous element is controlled by only one switch. The operating device in this case is connected to the mains voltage and switched on and off via a control input. For this purpose a pushbutton is used. If after switching-on the pushbutton is actuated in a specific way, for example is pressed for longer, then the operating device dims the luminous element within a defined range initially with decreasing luminosity and then with increasing luminosity (or vice versa). If the pushbutton is let go, the actual dimming setting is maintained. Such an operating device however has the drawback that it is permanently connected to the power system and hence causes standby losses.

It is further known for a dimming function by means of a light switch to be applied by a sequence of switching operations “on-off-on”. Once a desired dimming is achieved, it is stored by means of an “off” actuation of the light switch and the luminous element is disconnected. The next time the luminous element is switched on, the stored dimming value is automatically adjusted.

A further dimming method is so-called three-stage dimming that is commonly found above all in the NAFTA area. Here, two operating devices are fitted in a light fixture. Usually the first operating device operates one luminous element, the second operating device operates two luminous elements. The luminous elements all have a comparable capacity. The light fixture is controlled with two phases. Depending on which phase is connected, three dimming stages may be realized, the operating devices being triggered either individually or jointly. If only the first operating device is operated, one luminous element lights up. If only the second operating device is operated, two luminous elements light up and, if both operating devices are activated, all three luminous elements light up. Given luminous elements of identical capacity, these dimming stages enable luminosities of ca. 33%, 66% and 100%. With two operating devices this variant is very cost-intensive and entails a considerable installation outlay.

In the case of multi-stage electronic ballasts for dimming a luminous element, the mains voltage is connected in stages, and each switching state (realized for example with the aid of a plurality of switches) corresponds to a specific dimming setting. Current approaches have in particular the following drawbacks: a setpoint value for the adjustment of the dimming voltage that is derived from the voltage across the mains connections is dependent upon the level of the mains voltage. A strong line-side modulation of the control signals requires careful smoothing, which however is not to cause any overshoot during transfer of the mains connections. Externally connected loads across switched mains connections and/or X-capacitors provided there also often impair the dimming function.

The object of the invention is to avoid the previously described drawbacks and in particular to provide an efficient and economical way of dimming a luminous element.

This object is achieved in accordance with the features of the independent claims. Developments of the invention will also emerge from the dependent claims.

To achieve the object a circuit for dimming at least one luminous element is indicated,
Including at least two switching inputs and one N-connection,
wherein on the basis of a switching combination of the switching inputs the at least one luminous element is dimmable,
wherein as a function of a voltage shape across the N-connection the at least one luminous element is dimmable.

In particular, the voltage shape of the N-connection allows masking of the dimming functionality, i.e. dimming is possible in particular when the voltage shape across the N-connection meets a set condition. In this way a phase position between the signals across the switching inputs may be efficiently taken into consideration and hence the different switching combinations and/or switching states may be identified.

The N-connection is preferably a pole of an alternating voltage, while the other pole of the alternating voltage is connectable to the switching inputs. Here, it should be noted that the N-connection may be any pole of an alternating voltage.

It should further be noted that the term dimming may include a variation in the direction of increasing luminosity or in the direction of decreasing luminosity.

A development is such that as a function of the voltage shape across the N-connection the at least one luminous element is dimmable provided that the voltage across the N-connection is substantially zero or substantially negative compared to a frame of the circuit (and/or a frame potential of the circuit, also referred to as “ground” GND).

In particular it is thereby possible that for evaluation of the switching inputs only the positive half-waves of the mains voltage are taken into consideration: if during these positive half-waves a switching input indicates a corresponding voltage shape, it may be inferred that for the respective switching input the associated switch is also closed.

The present approach accordingly enables an efficient masking of the switching inputs. In this way interference and influences of X-capacitors and external loads across the L-connections are advantageously avoided.

Each switching input may be connected by a switch to a connection or a pole of the mains voltage (in particular to a so-called L-connection of the mains voltage).

Another development is such that with the aid of the voltage shape across the N-connection a phase position of the signals across the switching inputs is detectable.

In particular, a development is such that a mains voltage is provided with an L-connection and an N-connection, the L-connection of the mains voltage being connected to the at least two switching inputs.

It is also a development that with the aid of the switching combination of the switching inputs a setpoint value may be determined for adjusting a lamp controller.

It is further a development that a microcontroller is provided for determining the setpoint value and for adjusting the lamp controller.

In an additional development the microcontroller establishes whether the voltage across the N-connection is substantially zero or substantially negative compared to an internal frame of the circuit.

In particular, the previously described masking functionality may be realized with the aid of the microcontroller.

A next development is such that the setpoint value is adjustable largely independently of a voltage fluctuation of the mains voltage.

The switching inputs may accordingly be configured so as to be decoupled from the setpoint value.

A refinement is such that a variation of the switching combination occurs in a largely overshoot-free manner.

An alternative embodiment is such that for each switching input a threshold value comparison may be carried out.

A next refinement is such that a filter is provided for reducing power-frequency modulations.

It is also a refinement that the switching combinations of the switching inputs are linked to preset luminosities of the at least one luminous element.

Such a linking may for example be such that preset values are stored (for example in the form of a value table) or that a circuit is parameterized (for example by means of voltage dividers) in such a way that preset values or signals to a lamp controller may be generated for adjusting the luminosity of the at least one luminous element.

A development is such that the circuit includes or is a circuit of an electronic control gear or an extension of a circuit of an electronic control gear.

The previously described object is also achieved by a method for dimming at least one luminous element,
in which as a function of a switching combination of switching inputs the at least one luminous element is dimmed,
wherein as a function of a voltage shape across an N-connection the at least one luminous element is dimmed.

A refinement is such that as a function of the voltage shape across the N-connection the at least one luminous element is dimmed if the voltage across the N-connection is substantially zero or substantially negative compared to an internal frame of the circuit.

Another refinement is such that with the aid of the switching combination of the switching inputs a setpoint value is determined and as a function of the determined setpoint value a luminosity of the at least one luminous element is adjusted.

It is also a possibility that with the aid of the voltage shape across the N-connection a phase position of the signals across the switching inputs is determined.

To achieve the object a lamp, light fixture or a lighting system is indicated, including a circuit of the type described here.

There now follows a description of exemplary embodiments of the invention with reference to the drawings, in which:

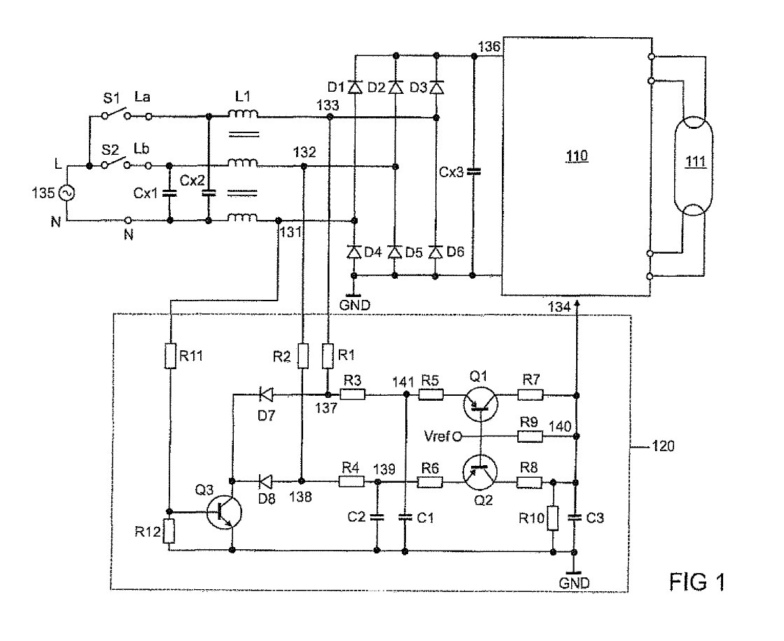

FIG. 1 shows an example of a circuit for an ECG with a dimming functionality;

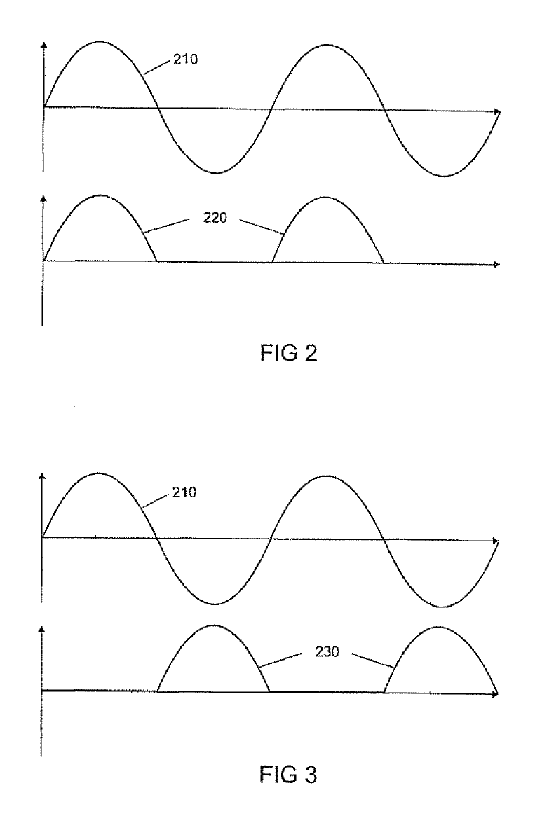

FIG. 2 shows a voltage shape of the mains voltage (voltage shape between the connections L and N) and a voltage shape between the connections L and the ground GND;

FIG. 3 shows the voltage shape of the mains voltage (voltage shape between the connections L and N) and a voltage shape between the connection N and the ground GND;

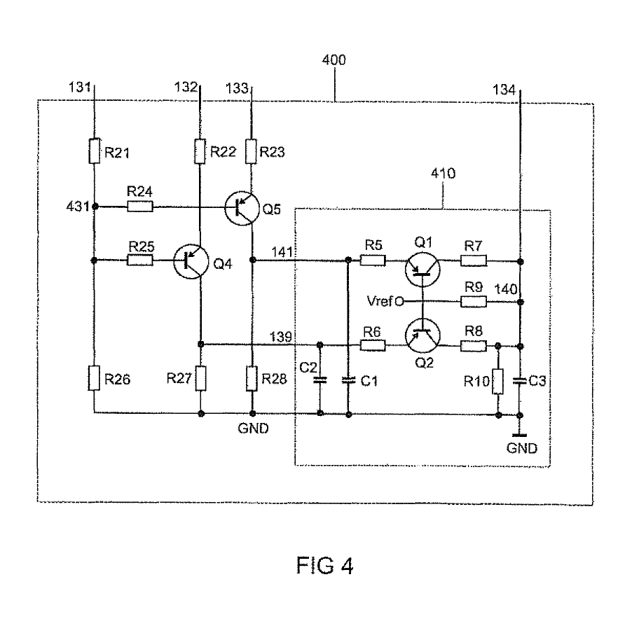

FIG. 4 shows a circuit variant, in which the two inputs of the dimming controller are not short-circuited but interrupted so long as the voltage V_{N-GND} is positive.

The present approach enables an efficient dimming of at least one luminous element, in particular of at least one lamp or light-emitting diode. For example, the at least one luminous element is supplied with electric current via at least one lamp controller.

For example, by means of a circuit including one input per mains connection (L) preferably by means of a prefilter, a threshold and/or a follow-up filter a power-frequency modulation of the control signals is suppressed. Overshoots during the transfer between the mains inputs are preferably reduced or (largely) avoided. Such overshoots are based for example on a changed signal being already present before the previous signal has decayed. The circuit may also within wide limits keep a setpoint power value (almost) constant independently of the level of the mains voltage.

The proposed approach advantageously evaluates the voltage across an N-connection of the mains voltage and deactivates the drive control circuit and/or dimming controller so long as the voltage across the N-connection is positive compared to an internal frame potential. In this way interference by X-capacitors and external loads across the L-connections is effectively avoided.

Here, it is particularly advantageous that a maximum number of power stages may be realized with a specific number of power cables (for example 3 different power stages with two L-connections and/or 7 different power stages with 3 L-connections—in addition to the “power status” of the disconnected luminous element).

It is further advantageous that a power constancy that is customary with an electronic control gear (light is within wide limits independent of the level of the mains voltage) may be maintained.

It is also advantageous that a power-frequency luminous flux modulation is not particularly pronounced. The power stages or dimming stages may be changed over without overshoots. Function is not impaired by any loads across the switched L-connections.

A multi-stage electronic control gear (ECG) for dimming at least one luminous element is described by way of example.

The luminous element may be luminous elements of any desired design. The luminous element is preferably supplied from a lamp controller, which in turn may be correspondingly controlled by means of the dimming controller.

Here, it should be noted that the dimming controller and the lamp controller may be implemented in a single device or in different devices. For example, it is possible to provide the dimming controller separately for one luminous element or for a plurality of luminous elements, in which case each luminous element may be equipped together with an individual lamp controller (in particular with an individual ECG).

So, here, by way of example an ECG with dimming controller for a luminous element is described. In a corresponding manner the dimming controller might be implemented separately from the ECG and/or a plurality of luminous elements might be correspondingly controlled.

The multi-stage ECG with dimming controller includes in particular two L-connections La, Lb and an N-connection. The desired dimming setting (luminosity of the luminous element) may be adjusted by the position of two switches S1 and S2 in accordance with the following value table:

| S1 | S2 | Dimming setting |
|---|---|---|
| off | off | off |
| on | off | 10% |
| off | on | 33% |
| on | on | 100% |

FIG. 1 shows an example of a circuit for an ECG with a dimming functionality.

An alternating voltage or mains voltage 135 has an L-connection and an N-connection. The L-connection of the mains voltage 135 is connected by a series circuit including a switch S1 and a first winding of a filter choke L1 to a node 133. The L-connection of the mains voltage 135 is further connected by a series circuit including a switch S2 and a second winding of the filter choke L1 to a node 132. The N-connection of the mains voltage 135 is connected by a third winding of the filter choke L1 to a node 131. The centre tap of the series circuit including the switch S2 and the second winding of the filter choke L1 is connected by an X-capacitor Cx1 to the N-connection, and the centre tap of the series circuit including the switch S1 and the first winding of the filter choke L1 is connected to the N-connection.

A node between the switch S1 and the first winding of the filter choke L1 is referred to as connection La. In a corresponding manner a node between the switch S2 and the second winding of the filter choke L1 is referred to as connection Lb.

The node 133 is connected to the anode of a diode D3 and to the cathode of a diode D6. The cathode of the diode D3 is connected to a node 136, and the anode of the diode D6 is connected to ground GND. The node 132 is connected to the anode of a diode D2 and to the cathode of a diode D5. The cathode of the diode D2 is connected to the node 136, and the anode of the diode D5 is connected to ground GND. The node 131 is connected to the anode of a diode D1 and to the cathode of a diode D4. The cathode of the diode D1 is connected to the node 136, and the anode of the diode D4 is connected to ground GND.

Between the node 136 and ground GND an X-capacitor Cx3 is provided.

A lamp controller 110 is connected at the input side to the node 136 and to ground GND. A luminous element 111 is connected to the output of the lamp controller 110. The lamp controller 110 further includes an input 134, with the aid of which a luminosity of the lamp 111 is adjustable.

The value for adjusting the luminosity is supplied to the input 134 of the lamp controller 110 by means of a dimming controller 120. The dimming controller 120 is connected at the input side to the nodes 131, 132 and 133.

There now follows a detailed description of the dimming controller 120:

The node 131 is connected by a resistor R11 to the base of an n-p-n-transistor Q3. Between the base and the emitter of the transistor Q3 a resistor R12 is provided, the emitter of the transistor Q3 being connected to ground GND. The collector of the transistor Q3 is connected to the cathode of a diode D8 and to the cathode of a diode D7. The anode of the diode D8 is connected to a node 138. The node 138 is connected by a resistor R2 to the node 132. The node 138 is also connected by a resistor R4 to a node 139. Between the node 139 and ground GND a capacitor C2 is provided. The node 139 is connected by a resistor R6 to the emitter of a p-n-p transistor Q2. The collector of the transistor Q2 is connected by a resistor R8 to the node 140. Between the node 140 and ground GND in each case a resistor R10 and a capacitor C3 are disposed. The base of the transistor Q2 is connected to a connection for a reference voltage Vref, to the base of a p-n-p transistor Q1 and by a resistor R9 to the node 140. The collector of the transistor Q1 is connected by a resistor R7 to the node 140. The emitter of the transistor Q1 is connected by a resistor to the node 141. The node 141 is connected by a capacitor C1 to ground GND. The node 141 is further connected by a resistor R3 to a node 137. The node 137 is connected to the anode of the diode D7 and by a resistor R1 to the node 133.

The node 140 is connected to the input 134 of the lamp controller 110.

To effectively enable the dimming functionality, the two L-connections La and Lb are preferably configured to supply the luminous element and/or the lamp controller. For this purpose each L-connection La and Lb and the N-connection includes an individual pair of diodes (La: D3, D6; Lb: D2, D5; N: D1, D4) for rectifying the alternating voltage 135. The rectified alternating voltage 136 is supplied to the lamp controller 110.

The current-compensated filter choke L1 is preferably provided for radio interference suppression and includes three windings, one winding each for the two L-connections La and Lb and the N-connection.

At least one X-capacitor (Cx1, Cx2) is further provided upstream or downstream of the filter choke L1 (upstream of the rectifier). Downstream of the rectifier (according to FIG. 1: diodes D1 to D6 for rectification) a joint X-capacitor Cx3 may be provided at the input of the lamp controller 110.

### Setpoint Value Generation

The dimming controller 120 as a function of the voltage across the L-connections La, Lb generates for the lamp controller 110 a setpoint value (at the node 140) that corresponds to the desired dimming setting.

FIG. 2 shows a voltage shape 210 of the mains voltage 135 (voltage shape between the connections L and N) as well as a voltage shape 220 between the connections L and ground GND.

In the closed state of the switch S1 the voltage shape 220 corresponds to the voltage shape across the node La, i.e. the voltage V_{L-GND} across La compared to the internal frame GND includes the illustrated power-frequency sinusoidal half-waves 220.

These sinusoidal half-waves 220 are used to charge the capacitor C1 via the resistors R1 and R3 up to a voltage that is approximately two to three times higher than the reference voltage Vref (ca. 5V). Because of the relatively low capacitance of the capacitor C1, the voltage across the node 141 presents a still significant power-frequency modulation. If this voltage across the node 141 is always higher than a voltage Vref+0.6V, the transistor Q1 is continuously activated via the resistor R5 and holds its collector at the potential of the reference voltage Vref. A current flow through the resistor R7 is therefore achieved, which is on the one hand practically free of power-frequency modulation and on the other hand within wide limits independent of the level of the mains voltage.

The slight residual modulation because of the ultimately steep base-emitter characteristic curve of the transistor Q1 is smoothed further by the capacitor C3. The voltage across the resistor R10 that arises because of the current flow through the resistor R7 corresponds to a setpoint value for the lamp controller 110 and determines the power stage (dimming stage) for the switch settings S1=on and S2=off.

This applies analogously to the closing of the switch S2 and the path from the switch S2 to the resistor R8. Thus, two power stages and/or dimming stages may be adjusted via the resistors R7 and R8 respectively.

An upper power stage and/or dimming stage may be composed of the sum of the two previously described dimming stages (both switches S1 and S2 are closed). The signal supplied to the lamp controller 110 across its input 134 for adjusting the luminosity of the luminous element 111 is correspondingly summed.

It is moreover also possible for this upper power stage to differ from the sum of the two lower power stages. This may be adjusted via the resistor R9, which if desired may alternatively be connected between the reference voltage Vref and the actual-value input of the controller. Thus, three power stages and/or dimming stages may be adjusted via the resistors R7, R8, R9.

### In-Phase Evaluation

In the switched-off state of the switches S1 or S2, the L-connections La, Lb are not voltage-free compared to the internal frame GND but are pulled by the X-capacitors Cx1 and/or Cx2 or alternatively by externally connected loads towards N-potential V_{N-GND}.

FIG. 3 shows the voltage shape 210 of the mains voltage 135 (voltage shape between the connections L and N) as well as a voltage shape 230 (V_{N-GND}) between the connection N and ground GND.

The voltage shapes V_{L-GND} 220 of FIG. 2 and V_{N-GND} 230 of FIG. 3 differ in their phase position.

In order to establish whether the switch S1 or the switch S2 is/are closed, the phase position of the voltages across the connections La and/or Lb therefore has to be evaluated. This occurs by means of the transistor Q3, which is connected conductively by the resistor R11 so long as the voltage V_{N-GND} 230 is positive. In this situation the two inputs of the dimming controller 120 are short-circuited by the diodes D7 and D8. The effect thereby achieved is that only the evaluation of in-phase signals occurs. The two diodes D7 and D8 are used in this case to decouple the two inputs (i.e. the nodes 132 and 133).

### Overshoot

During transfer between the two lower dimming stages, i.e.

S1=on, S2=off<−>S1=off, S2=on

it is advantageous that the capacitor C1 and/or the capacitor C2 is discharged in each case rapidly enough to prevent the transistor Q1 and the transistor Q2 from being simultaneously conductive. Otherwise, for a short time the upper dimming stage would be adjusted.

A rapid discharge of the capacitors C1 and C2 may be achieved in each case by selection of a relatively low capacitance, assisted by a periodic stronger discharge by means of the transistor Q3 and the resistors R3 and/or R4.

The embodiment of the thresholds by means of the transistors Q1 and Q2 in common base has proved particularly advantageous compared to a simple voltage limitation by means of diodes: this means that the capacitors C1 and C2 do not have to be fully discharged, rather a discharge to the level of the reference voltage Vref is sufficient to block the respective signal path.

### Alternative Circuit (s)

FIG. 4 shows a circuit variant, in which the two inputs of the dimming controller 120 are not short-circuited but interrupted so long as the voltage 230 V_{N-GND} is positive.

FIG. 4 shows, in comparison with FIG. 1, a modified dimming controller 400. The wiring of the dimming controller 400 may be in accordance with FIG. 1. This is characterized by the connections of the dimming controller 400 to the nodes 131, 132 and 133 as well as to the input 134 of the lamp controller 110 according to FIG. 1.

A block 410 within the dimming controller 400 is also to be found in the dimming controller 120 according to FIG. 1. The block 410 may be identified by means of the nodes 139, 141 and 140 according to FIG. 1. Reference is made accordingly to the description of FIG. 1.

There now follows a detailed description of the dimming controller 400 according to FIG. 4:

The node 131 is connected by a resistor R21 to a node 431. Between the node 431 and ground GND a resistor R26 is disposed.

The node 431 is connected by a resistor R24 to the base of a p-n-p transistor Q5. The emitter of the transistor Q5 is connected by a resistor R23 to the node 133. The collector of the transistor Q5 is connected on the one hand to the node 141 and on the other hand by a resistor R28 to ground GND.

The node 431 is connected by a resistor R25 to the base of a p-n-p transistor Q4. The emitter of the transistor Q4 is connected by a resistor R22 to the node 132. The collector of the transistor Q4 is connected on the one hand to the node 139 and on the other hand by a resistor R27 to ground GND.

The dimming controller 400 utilizes the two transistors Q4 and Q5, which are only conductively connected by the resistor R21, so long as the voltage V_{N-GND} is sufficiently low.

As the dimming controller 400 has no means of periodically discharging the two capacitors C1 and C2, the resistors R28 and R27 here are each connected to ground in order to ensure a sufficiently rapid discharge during transfer between the dimming stages.

A further alternative for scanning the states of the switches S1 and S2 is the use of a microcontroller. Thus, it is possible by means of the microcontroller to scan the voltage V_{N-GND} and, if this voltage is precisely zero or below a specific limit value, to determine an actual setpoint value from the two voltages V_{La-GND} and V_{Lb-GND} in accordance with the above value table.

The approach proposed here may be used to dim any desired luminous element. In particular a staged dimming may be achieved in an efficient manner. Possible areas of application relate to emergency lighting systems or tunnel lighting systems.

1. A circuit for dimming at least one luminous element, the circuit comprising:
at least two switching inputs and an N-connection,
wherein on the basis of a switching combination of the switching inputs the at least one luminous element is dimmable,
wherein as a function of a voltage shape across the N-connection the at least one luminous element is dimmable.

2. The circuit as claimed in claim 1,
wherein as a function of the voltage shape across the N-connection the at least one luminous element is configured to be dimmable provided that the voltage across the N-connection is substantially zero or substantially negative compared to an internal frame of the circuit.

3. The circuit as claimed in claim 1,
wherein with the aid of the voltage shape across the N-connection a phase position of the signals across the switching inputs is detectable.

4. The circuit as claimed in claim 1,
wherein a mains voltage is provided with an L-connection and with an N-connection, the L-connection of the mains voltage being connected to the at least two switching inputs.

5. The circuit as claimed in claim 1,
wherein with the aid of the switching combination of the switching inputs a setpoint value is determinable for adjusting a lamp controller.

6. The circuit as claimed in claim 5, further comprising:
a microcontroller configured to determine the setpoint value and to adjust the lamp controller.

7. The circuit as claimed in claim 6,
wherein the microcontroller is configured to establish whether the voltage across the N-connection is substantially zero or substantially negative compared to an internal frame of the circuit.

8. The circuit as claimed in claim 5,
wherein the circuit is configured such that the setpoint value is adjustable largely independently of a voltage fluctuation of the mains voltage.

9. The circuit as claimed in claim 1,
wherein a variation of the switching combination occurs in a largely overshoot-free manner.

10. The circuit as claimed in claim 1,
wherein the circuit is configured such that for each switching input a threshold value comparison is carried out.

11. The circuit as claimed in claim 1,
wherein a filter is provided for reducing power-frequency modulations.

12. The circuit as claimed in claim 1,
wherein the switching combinations of the switching inputs are linked to preset luminosities of the at least one luminous element.

13. The circuit as claimed in claim 1,
wherein the circuit comprises or is a circuit of an electronic control gear or an extension of a circuit of an electronic control gear.

14. A method for dimming at least one luminous element, the method comprising:
dimming the at least one luminous element as a function of a switching combination of switching inputs; and
dimming the at least one luminous element as a function of a voltage shape across an N-connection.

15. The method as claimed in claim 14,
wherein as a function of the voltage shape across the N-connection the at least one luminous element is dimmed if the voltage across the N-connection is substantially zero or substantially negative compared to an internal frame of the circuit.

16. The method as claimed in claim 14,
wherein with the aid of the switching combination of the switching inputs a setpoint value is determined and as a function of the determined setpoint value a luminosity of the at least one luminous element is adjusted.

17. The method as claimed in claim 14,
wherein with the aid of the voltage shape across the N-connection a phase position of the signals across the switching inputs is determined.
